(19) United States
(12) Patent Application Publication
(10) Pub. No.: US 2026/0368817 A1
(43) Pub. Date: Nov. 19, 2026

(54) System and Method for Creating Financial Indices and Dynamic Investment Portfolios Using a Cyclically Adjusted Enterprise Value to EBIT Ratio (CAEE)

(71) Applicant: Dale Raimann, Kansas City, MO (US)

(72) Inventor: Dale Raimann, Kansas City, MO (US)

(73) Assignee: Dale's Solo Investors Podcast, LLC., Harrisonville, MO (US)

(21) Appl. No.: 19/208,614

(22) Filed: May 15, 2025

Related U.S. Application Data
(60) Provisional application No. 63/788,836, filed on Apr. 15, 2025.

(51) Int. Cl. G06Q 40/06

(52) U.S. Cl. CPC G06Q 40/06

(57) ABSTRACT

The present invention relates to a system and method for ranking and selecting publicly traded securities based on the Cyclically Adjusted Enterprise Value to EBIT (CAEE) ratio. Securities are ranked into deciles or percentiles or quantiles within a defined universe of stocks. The invention enables the construction of financial indices and dynamic, rules-based investment portfolios by selecting securities from the most favorable CAEE ratio deciles or percentiles or quantiles, which are presumed to represent attractive long-term valuations based on economic rationale. Rebalancing is performed automatically based on changes in a security's decile or percentile or quantile membership. The invention applies across multiple indices and index universes and supports the creation of custom indices, portfolios, and investment vehicles including but not limited to: ETFs (exchange traded funds), ETPs (exchange traded products), MFs (mutual funds), ETNs (exchange-traded notes), direct indexing strategies, SMAs (separately managed accounts), and algorithmic trading systems.

### BACKGROUND OF INVENTION

Traditional financial valuation metrics, such as the Price-to-Earnings (P/E) ratio and Enterprise Value to EBIT (EV/EBIT) ratio, often fail to account for long-term earnings trends and cyclicality, leading to distorted or incomplete insights about a company's true valuation. There is a need for smoothing (e.g. multi-year averaging) and inflation adjustment to obtain a more stable valuation metric. The Cyclically Adjusted Enterprise Value to EBIT (CAEE) ratio solves issues by incorporating a 10-year inflation-adjusted average of EBIT, providing a more stable and predictive measure of a company's valuation across economic cycles.

### Definition and Calculation of CAEE (Cyclically Adjusted Enterprise Value to EBIT)

### Cyclically Adjusted Enterprise Value to EBIT (CAEE)=Enterprise Value/10-Year Average Inflation-Adjusted EBIT

The CAEE ratio is calculated by dividing a company's current Enterprise Value (EV) by the average of its inflation-adjusted EBIT (Earnings Before Interest and Taxes) over the past 10 years. This method smooths out earnings volatility and adjusts for inflation to provide a more stable valuation metric.
Step-by-Step Calculation
Calculate Enterprise Value (EV):
Enterprise Value is defined as:
EV=Market Capitalization+Total Debt−Cash and Cash Equivalents
Collect 10 Years of EBIT:
Retrieve the company's EBIT for each of the last 10 fiscal years from public financial statements or financial data providers.
Adjust Each Year's EBIT for Inflation:
For each year, adjust the EBIT to present-day dollars using the Consumer Price Index (CPI) or a similar inflation index.
Each year's adjusted EBIT is calculated as:
Adjusted EBIT=Reported EBIT×(Current CPI/CPI for that Year)
Calculate the 10-Year Average of Adjusted EBIT:
Add the 10 inflation-adjusted EBIT values together and divide by 10.
This gives the average inflation-adjusted EBIT over the past 10 years.
Divide EV by the 10-Year Average Adjusted EBIT:
Finally, compute the CAEE ratio as:
CAEE=Enterprise Value/10-Year Average Inflation-Adjusted EBIT

This invention formalizes and systematizes the use of the CAEE ratio in the construction of financial indices and dynamic investment portfolios. The CAEE based indices and portfolios differ from traditional metrics like the Shiller CAPE@ Index or other ETF's (e.g. ticker symbol: CAPE), and are tied to specific data-processing steps. In implementation, the invention comprises software modules on a non-transitory medium or a computing device that perform the CAEE computation, stock ranking, index or portfolio construction, and automated threshold rebalancing. I believe this targeted, computer-implemented approach ensures patent eligibility and provides novel, non-obvious value-oriented index construction and portfolio construction under § § 102/103 by combining the specific CAEE formula, ranking logic, selection logic, weighting logic, and automated threshold rebalancing process.

### A Formula Mentioned in the Dependent Claims:

In certain industries, such as banking, insurance, or other financial institutions, EBIT may not accurately reflect core operating performance because interest income and interest expense are inherent to their business models. EBIT is designed to exclude interest expense, which in these sectors removes a central operating component. Therefore, the CAEE ratio may not apply as intended. To account for this, in some embodiments the system substitutes the CAEE ratio with a cyclically adjusted Price-to-Tangible-Book-Value (CAPTBV) ratio, using a ten-year average of inflation-adjusted tangible book value as the denominator. The CAPTBV ratio is calculated below and further mentioned in the “Dependent Claims”.
Step-by-Step Calculation: CAPTBV (Cyclically Adjusted Price to Tangible Book Value):
1. Collect 10 Years of Tangible Book Value:
Retrieve the company's tangible book value (TBV) for each of the last 10 fiscal years.
Tangible book value is calculated as:
TBV=Total Assets−Intangible Assets−Total Liabilities
2. Adjust Each Year's TBV for Inflation:
Convert each historical TBV figure to present-day dollars using the Consumer Price Index (CPI) or a similar inflation index.
For each year, apply the following formula:
Adjusted TBV=Reported TBV×(Current CPI÷CPI for that Year)
3. Calculate the 10-Year Average of Adjusted TBV:
Sum the 10 inflation-adjusted TBV values.
Divide the sum by 10:
Average Inflation Adjusted TBV=(Sum of 10 Adjusted TBV Values)÷10
This produces a smoothed, inflation-adjusted base value.
4. Retrieve the current market price of a security (also known as Market Capitalization )
5. Compute the CAPTBV Ratio:
Divide the current Market Capitalization by the Average Inflation Adjusted TBV.
CAPTBV=Current Market Capitalization÷10-Year Average Inflation-Adjusted Tangible Book Value

### Related Art

Existing fundamental index methods use raw metrics and known index innovations incorporate value factors but do not specifically perform a rolling inflation-adjusted EBIT calculation and decile-based selection. Existing fundamental index methods often use “raw” financial data like Revenue, Earnings, Book value, Dividends, and Cash flow to rank and weight stocks in an index without smoothing or adjusting for inflation or business cycles.

These methods do not:
a. Apply 10-year rolling averages of earnings (like CAEE does)
b. Adjust historical earnings for inflation (like CAEE does)
c. Use valuation ratios like EV/EBIT in a cyclically adjusted format (like CAEE does)

Applying one known smoothing process, such as Shiller's CAPE@ ratio, to another known ratio could be seen as predictable. However, no commercial ETF or known system applies a cyclically adjusted ratio like CAEE (or even CAPE®) at the individual stock level, organizes them into deciles or percentiles or quantiles, and uses threshold-based inclusion/rebalancing logic within an equity universe, and applies it to a portfolio or managed investment product. Most commercial applications (like the DoubleLine CAPE@ ETF) apply the ratio at the sector level, not the security level. The DoubleLine Shiller CAPE@ U.S. Equities ETF (ticker symbol: CAPE), does not organize individual stocks CAPE@ ratios into groups (e.g. deciles, or percentiles, or quantiles) and invest in only the stocks with the lowest CAPE@ ratios or most favorable decile or percentile or quantile groups. Instead, the DoubleLine Shiller CAPE@ U.S. Equities ETF is a sector rotation strategy, so clearly, it is not sorting the lowest CAPE® ratio stocks into deciles, quantiles, or percentages, and investing in those individual stocks accordingly. If it were, it would have much more exposure to other sectors. As of May 13, 2025, the underlying holdings of the DoubleLine Shiller CAPE@ U.S. Equities ETF show virtually no Technology stocks, Healthcare stocks, Industrials stocks, Basic Materials stocks, Financial Services stocks, Utilities stocks, or Energy stocks.

The current allocation of ticker symbol “CAPE” is: Communication Services 24.79%, Real Estate 25.03%, Consumer Discretionary 24.47%, Consumer Staples 25.30% (DoubleLine Shiller CAPE® U.S. Equities ETF allocation as of May 13, 2025) . If the DoubleLine Shiller CAPE® U.S. Equities ETF were sorting the lowest CAPE® ratio stocks into deciles or quantiles or percentages groups, and investing in the most favorable group (e.g. the 10% of individual stocks with the lowest ratio CAPE@ values), the DoubleLine Shiller CAPE@ U.S. Equities ETF would have much more exposure to other sectors like the Technology, Healthcare, Industrials, Basic Materials, Financial Services, Utilities, and Energy sectors. Therefore, my system and method is novel and non-obvious. No known commercial ETF strategy presently applies a cyclically adjusted ratio, such as CAEE (Cyclically Adjusted Enterprise Value to EBIT), at the individual security level, ranks the full universe into deciles or quantiles or percentages groups based on that ratio, and uses threshold-based rebalancing to dynamically construct an index, portfolio, or investment product. This approach—combining stock-level CAEE calculation, ranking, selecting, weighting, and automated threshold rebalancing—represents a novel and non-obvious application of cyclically adjusted valuation metric, and is clearly distinct from sector-based CAPE@ implementations or traditional ETFs. With regards to the threshold-rebalancing aspect of the invention, conventional rebalancing methods generally do not automate portfolio rebalancing based on such ratios. Therefore, there is a need for a specific, computer-implemented system that does so. To my knowledge, the specific use of a 10-year average EBIT with inflation adjustment, combined with decile or quantile or percentile-based rebalancing and multi-index flexibility, is novel. The invention thus provides a new analytical tool and product: a “CAEE Index” and “CAEE portfolio” that systematically selects value stocks in a way not previously implemented.

### Commercial Based Use

To my knowledge, no one has used an enterprise value and a 10-year inflation adjusted EBIT average in a commercial based setting. Moreover, conventional methods generally do not automate portfolio rebalancing based on a cyclically adjusted ratio value falling above or below a certain threshold. Therefore, there is a need for a specific, computer-implemented system that follows these steps:
(a)retrieving stock price data and financial statements for a plurality of issuers;
(b)computing each issuer's enterprise value (EV) as the sum of its market capitalization and debt minus cash and cash equivalents;
(c)computing each issuer's inflation-adjusted average EBIT (earnings before interest and taxes) over a ten-year period (e.g. by adjusting each year's EBIT for inflation and averaging);
(d)computing a CAEE ratio for each issuer by dividing its EV by the ten-year adjusted EBIT average;
(e)ranking securities by each calculated CAEE ratio into deciles, quantiles, or percentages;
(f)grouping the ranked list into decile, quantile, or percentage buckets;
(g)and constructing a portfolio or index comprising those issuers whose CAEE values fall within one or more predetermined deciles, quantiles, or percentages (the lowest decile, quantile, or percentage group of CAEE values may represent the lowest CAEE value stocks within a specific index. For the purposes of this methodology, the “top decile” refers to the 10% of securities within an index with the lowest ratio values-indicating most favorable valuations);
(h)The method further includes weighting the selected stocks in the portfolio (such as equal-weighting, factor-weighting, market-cap weighting, composite-score weighting, or other weighting logic) and automatically rebalancing the portfolio when a stocks CAEE ratio moves outside the original decile, quantile, or percentage threshold.

This system and method can assist in finding value investing opportunities, as prior analysis has shown that using a regular EV/EBIT metric can create alpha.

### SUMMARY OF THE INVENTION

In one aspect, the present invention provides a method for creating a dynamic investment strategy or portfolio and custom index based on a cyclically adjusted enterprise-value to EBIT ratio (“CAEE”).

The method includes the following steps:
(a)retrieving stock price data and financial statements for a plurality of issuers;
(b)computing each issuer's enterprise value (EV) as the sum of its market capitalization and debt minus cash and cash equivalents;
(c)computing each issuer's inflation-adjusted average EBIT (earnings before interest and taxes) over a ten-year period (e.g. by adjusting each year's EBIT for inflation and averaging);
(d)computing a CAEE ratio for each issuer by dividing its EV by the ten-year adjusted EBIT average;
(e)ranking securities by each calculated CAEE ratio into deciles, quantiles, or percentages;
(f)grouping the ranked list into decile, quantile, or percentage buckets;
(g)and constructing a portfolio or index comprising those issuers whose CAEE values fall within one or more predetermined deciles, quantiles, or percentages (the lowest decile, quantile, or percentage group of CAEE values may represent the lowest CAEE value stocks within a specific index. For the purposes of this methodology, the “top decile” refers to the 10% of securities within an index with the lowest ratio values-indicating most favorable valuations);
(h)The method further includes weighting the selected stocks in the portfolio (such as equal-weighting, factor-weighting, market-cap weighting, composite-score weighting, or other weighting logic) and automatically rebalancing the portfolio when a stocks CAEE ratio moves outside the original decile, quantile, or percentage threshold.

In another aspect, the invention provides a computer-implemented system or apparatus for carrying out the above method. The system comprises one or more processors and a non-transitory computer-readable memory storing instructions. When executed by the processor, the instructions cause the system to perform the first aspects steps of:
(a)retrieving stock price data and financial statements for a plurality of issuers;
(b)computing each issuer's enterprise value (EV) as the sum of its market capitalization and debt minus cash and cash equivalents;
(c)computing each issuer's inflation-adjusted average EBIT (earnings before interest and taxes) over a ten-year period (e.g. by adjusting each year's EBIT for inflation and averaging);
(d)computing a CAEE ratio for each issuer by dividing its EV by the ten-year adjusted EBIT average;
(e)ranking securities by each calculated CAEE ratio into deciles, quantiles, or percentages;
(f)grouping the ranked list into decile, quantile, or percentage buckets;
(g)and constructing a portfolio or index comprising those issuers whose CAEE values fall within one or more predetermined deciles, quantiles, or percentages (the lowest decile, quantile, or percentage group of CAEE values may represent the lowest CAEE value stocks within a specific index. For the purposes of this methodology, the “top decile” refers to the 10% of securities within an index with the lowest ratio values-indicating most favorable valuations);
(h)The system further includes weighting the selected stocks in the portfolio (such as equal-weighting, factor-weighting, market-cap weighting, composite-score weighting, or other weighting logic) and automatically rebalancing the portfolio when a stocks CAEE ratio moves outside the original decile or quantile or percentage threshold.

Each step above corresponds to modules in the computing system. The system includes modules for performing each function (data retrieval, CAEE calculation, ranking, selection, weighting, and order execution), and may connect to data feeds and trading interfaces. In some embodiments, the system also computes risk or variance metrics on the selected portfolio.

I believe this invention's novel combination of steps and technical implementation ensures patent-eligible subject matter and overcomes prior art. Unlike abstract financial heuristics, each step is a concrete computational process running on standard computing hardware. Also, unlike existing investible commercial investment products or portfolios, which do not apply cyclically adjusted ratios at the individual security level, this system ranks all securities into deciles or quantiles or percentages based on CAEE and uses threshold-based rebalancing to dynamically manage portfolio composition. The integration of this specific formula, ranking logic, selection logic, weighting logic, and automated rebalancing through a computer-implemented mechanism represents a novel and non-obvious advancement. As such, I believe the invention satisfies the requirements of 35 U.S.C. §§ 101, 102, and 103 for patentable subject matter, novelty, and inventive steps, particularly in contrast to conventional approaches like Shiller's CAPE®.

### DETAILED DESCRIPTION OF THE INVENTION

The invention can be implemented in software executed on a general-purpose computer or server. In an embodiment, the system periodically receives or retrieves stock price data (e.g. end-of-day or real-time prices) and financial statement data for a set of companies (e.g. from a market data provider or public filings). For each company, the system computes Enterprise Value (EV) as the sum of its market capitalization plus total debt, minus cash and cash equivalents. Concurrently, the system computes the company's ten-year inflation-adjusted average Earnings Before Interest and Taxes (EBIT). The system can adjust each of the past ten years' EBIT figures to constant dollars using a consumer price index (e.g. from the FRED system or public filings), then average those ten real values to obtain a smoothed EBIT figure. (This parallels the CAPE® approach of averaging ten years of inflation adjusted earnings.) The division of EV by this smoothed EBIT yields the Cyclically Adjusted EV/EBIT ratio (CAEE) for that company. Once CAEE ratios are calculated for all companies in the universe, the system ranks them in ascending order (lowest CAEE=higher relative value). The sorted list is partitioned into quantile or percentile or decile buckets. (Decile buckets contain 10% of the universe. Let Decile 1 be the 10% of stocks with the lowest CAEE, Decile 2 the next 10%, and so on all the way to Decile 10).

In one embodiment, the portfolio or index is constructed by selecting companies from one or more of the top deciles (e.g. Decile 1 and/or Decile 2). The system may select all companies in Decile 1 for inclusion. Alternatively, selection could be based on a CAEE threshold value corresponding to the decile cut-off. These selection criteria define the index's or portfolio's constituents. The system then determines weighting for each selected company. In one embodiment, the portfolio is equally weighted, so each selected stock has the same allocation.

Equal-weighting ensures the index performance is driven by valuation selection rather than market capitalization. In other embodiments, weighting can be proportional to the inverse of CAEE (lower CAEE=larger weight) or other weighting embodiments mentioned in section (h) under the “Summary of Invention” section above. After weighting is applied, the system outputs the target portfolio weights for implementation (e.g. generating orders to buy each stock or creating ETF shares). Importantly, the portfolio is rebalanced automatically upon triggered events. At each rebalance time, the system repeats the data retrieval and CAEE computation and updates which companies fall into the target deciles or quantiles or percentiles. If a company moves out of the decile or quantile or percentile (e.g. its CAEE rises above the cut-off), it is removed from the index or portfolio, and companies that newly enter the decile or quantile or percentile are added. New weights are then calculated (e.g. equally weighting or other weighting embodiments). The system then executes trades to adjust the holdings. This automated threshold rebalancing ensures the index continuously reflects the most favorable CAEE opportunities. The system transmits portfolio construction output to a user-facing application, external API, or broker-dealer platform in a standardized format (e.g., CSV, JSON, or FIX protocol) to enable execution of the portfolio or custom index or index-based strategies. This communication allows the portfolio or custom index or index-based strategy to be integrated with downstream systems for trading, auditing, or client reporting.

The above steps are performed by software modules on a computing platform. The system includes one or more processors (CPU/GPU) and memory storing program instructions. The instructions implement modules such as: a Data Retrieval Module (which pulls pricing and EBIT data), a CAEE Calculator (which computes inflation-adjusted EBIT averages and EV/EBIT ratios), a Ranking Module (which sorts and splits deciles or quantiles or percentiles), a Selection Module (which selects decile or quantile or percentile constituents), and a Portfolio Manager (which computes weights and issues threshold rebalance trades).

The system retrieves live or archived financial data via a network interface from external data providers (e.g., Bloomberg, EDGAR, Compustat, Yahoo Finance, Nasdaq, Morningstar, Thomson Reuters, or Factset) and stores said data in a structured format in system memory for processing. The hardware may connect to financial databases, exchange APIs, and user interfaces as needed. This apparatus automatically performs the CAEE index construction and the CAEE portfolio construction. The invention is tied to specific hardware/software components: the processor and memory executing the CAEE algorithms. This setup ensures that the invention is a practical data processing system under 35 U.S.C. § 101. The foregoing detailed description is provided to illustrate specific embodiments of the invention and is not intended to limit its scope. One skilled in the art will recognize that variations are possible.

Variations may include the following:
(a) The rebalancing method can also include time based rebalancing (e.g. monthly, annually, semi-annually, weekly, daily) or tolerance bands or minimum CAEE gap thresholds to avoid excessive turnover.
(b) The ranking mechanism may sort securities into deciles, or quantiles, or percentages, or other ordinal ranking methodologies, based on their CAEE ratio, with the lowest CAEE ratio securities being the most favorable for selection. The ranking methodology is not limited to any specific quantile or percentile or decile grouping and may include any comparative framework that orders securities based on valuation attractiveness.
(c) While the above description often refers to selecting the lowest decile of CAEE, embodiments may select multiple deciles (e.g. bottom two deciles) or use percentile cutoffs.
(d) The CAEE denominator could alternatively be a seven-year or fifteen-year inflation-adjusted EBIT average, although ten years is a typical choice.
(e) Weighting schemes can vary (equal weight, factor weight, etc).
(f) Rebalancing triggers could include volatility thresholds or tax considerations.
(g) A dynamic rebalancing mechanism could automatically adjust portfolio composition and/or weighting when securities enter or exit a predefined CAEE decile, quantile, or percentile range.
(h) A rules-based methodology for constructing indices or portfolios where only securities from the most favorable CAEE deciles, quantiles, or percentiles could be included.

All such modifications use the same core inventive concepts: a cyclically-adjusted EV/EBIT ratio and computer-implemented portfolio logic.

### Limitations

In certain industries, such as banking, insurance, or other financial institutions, EBIT may not accurately reflect core operating performance because interest income and interest expense are inherent to their business models. EBIT is designed to exclude interest expense, which in these sectors removes a central operating component. Therefore, the CAEE ratio may not apply as intended. To account for this, in some embodiments the system substitutes the CAEE ratio with a cyclically adjusted Price-to-Tangible-Book-Value (CAPTBV) ratio, using a ten-year average of inflation-adjusted tangible book value as the denominator.

### Single-Index Application or Multiple Indices Application:

The system and method constructs a financial index using the CAEE ratio, and can be applied to a single index, such as but not limited to, the S&P 500. The system and method can also be applied to multiple widely recognized indices, such as the S&P 500, S&P MidCap 400, S&P SmallCap 600, and Russell 2000, or any other custom-defined index universe, enabling the creation of diversified financial products, custom indices, licensing models for portfolio managers, and licensing index data for financial products.

### Portfolios and Investment Vehicles:

The system and method constructs portfolios and investment vehicles including but not limited to, ETFs (exchange traded funds), ETPs (exchange traded products), MFs (mutual funds), ETNs (exchange-traded notes), direct indexing strategies, custom indices, SMAs (separately managed accounts), and algorithmic trading systems, which dynamically adjust portfolio composition based on changes in CAEE ratio decile, quantile, or percentile rankings. The system and method enables the creation of diversified financial products and licensing models for portfolio managers.

### Threshold-Triggered Adjustments:

The system and method includes a mechanism whereby portfolio holdings are automatically adjusted based on predefined thresholds related to the CAEE ratio and movements between deciles, quantiles, or percentiles across multiple index universes.

### Spreadsheets/Code Used:

The system and method may be implemented using spreadsheet tools, custom code (e.g. Python ), or a third party portfolio optimization platform. The system and method output may be configured for use in third-party tools, including but not limited to: rebalancing engines, investment screeners, data visualizations, risk models, and analytics dashboards. The methodology may be offered through an API interface for consumption by other systems, data providers, or platforms offering factor-based portfolio construction.

### Broad Scope of the Invention:

The CAEE ratio may be used independently or in combination with other ratios to select, rank, and rebalance securities across portfolios and investment vehicles such as ETFs, ETNs, ETPs, custom indices, SMAs, mutual funds, direct indexing platforms, and other structures governed by programmable or manual portfolio management rules.

### Software Implementation:

The system and method described may be implemented manually or in software-based systems. The screening, ranking, and rebalancing logic may be encoded into a computer algorithm, database-driven model, or automated trading interface, and executed programmatically across defined security universes.

### Supported Investment Vehicles:

This system and method can be implemented in portfolios including ETFs (exchange traded funds), ETPs (exchange traded products), MFs (mutual funds), ETNs (exchange-traded notes), direct indexing strategies, custom indices, SMAs (separately managed accounts), and algorithmic trading systems.

### Licensing and Commercial Application:

This system and method can be licensed to Index developers, Asset managers, Financial data providers, Platforms offering factor-based indexing, or custom quant solutions.

The following claims illustrate potential embodiments and are not intended to limit the scope of the invention, which encompasses any system that applies the CAEE ratio in the described manner:

1. A computer-implemented method of constructing a dynamic, valuation-based investment index or portfolio, the method comprising:
(a) accessing, by at least one data processor, financial data including enterprise values and historical earnings before interest and taxes (EBIT) for each of a plurality of publicly-traded securities in a defined universe;
(b) computing, by the at least one processor, for each security a cyclically adjusted EBIT value by calculating an inflation-adjusted multi-year average of the security's EBIT;
(c) computing, by the at least one processor, for each security a Cyclically Adjusted Enterprise Value to EBIT (CAEE) ratio by dividing the enterprise value of the security by its cyclically adjusted EBIT value;
(d) ranking, by the at least one processor, the plurality of securities in ascending order by their respective CAEE ratios and assigning each security to a decile, quantile, or percentage group;
(e) selecting, by the at least one processor, one or more securities from one or more predetermined decile, quantile, or percentage groups corresponding to the lowest CAEE ratio values in the defined universe;
(f) determining, by the at least one processor, portfolio weightings for the selected securities according to a predefined weighting rule;
(g) constructing, by the at least one processor, an output index or portfolio comprising the selected securities with the determined weightings; and
(h) automatically rebalancing, by at least one processor, the output portfolio when at least one of the selected securities enters or exits the one or more predetermined decile, quantile, or percentage groups.

2. The method of claim 1, wherein the defined universe comprises a set of publicly-traded equity securities selected according to one or more objective, predefined criteria including market capitalization range, exchange listing, minimum trading volume, domicile, or sector classification, wherein said criteria are defined prior to index or portfolio construction and applied uniformly across all constituent securities.

3. The method of claim 1, wherein computing the cyclically adjusted EBIT value for each security comprises adjusting each annual EBIT by a corresponding inflation index and averaging the inflation-adjusted annual EBIT values over at least a ten-year period.

4. The method of claim 1, wherein the partitioning scheme comprises dividing the ranked securities into ten equal-sized groups corresponding to deciles.

5. The method of claim 1, wherein selecting comprises selecting all securities in one or more decile, quantile, or percentage groups corresponding to the lowest CAEE ratios.

6. The method of claim 1, further comprising analyzing historical performance data of the decile, quantile, or percentage groups and identifying the one or more predetermined decile, quantile, or percentage groups based on highest historical returns.

7. The method of claim 1, wherein determining weightings comprises assigning equal weights to each selected security.

8. The method of claim 1, wherein determining weightings comprises assigning weights to the selected securities in proportion to a financial metric or factor score, selected from the group consisting of: Market capitalization weighting, Revenue weighting, Factor-based scoring, Composite scores, or user-defined rules stored in memory and executed by the processor.

9. The method of claim 1, wherein rebalancing is performed on a predetermined schedule consisting of weekly or bi-monthly or monthly or quarterly or annually or semi-annually.

10. The method of claim 1, wherein the the inflation data is retrieved from at least one publicly accessible source providing historical Consumer Price Index (CPI) data or an equivalent inflation measure, such as the U.S. Bureau of Labor Statistics, the World Bank, the Federal Reserve Bank of St. Louis (FRED database), or the U.S. Department of Labor.

11. The method of claim 1, wherein the output comprises a portfolio used to manage: ETFs (exchange traded funds), ETPs (exchange traded products), MFs (mutual funds), ETNs (exchange-traded notes), direct indexing strategies, SMAs (separately managed accounts), or Algorithmic trading systems.

12. The method of claim 1, wherein for securities classified as financial companies, including but not limited to banks, insurance firms, and investment companies, the processor substitutes the CAEE ratio with a cyclically adjusted price-to-tangible-book-value ratio (CAPTBV ratio), calculated by dividing the security's current market price by a multi-year inflation-adjusted average of tangible book value.

13. A computer system for constructing a dynamic, valuation-based investment index or portfolio, the system comprising:
(a) a memory storing financial data including enterprise values and historical EBIT values for a plurality of securities; and
(b) at least one processor in communication with the memory, the processor configured by executable instructions to:
(i) compute, for each security, an inflation-adjusted multi-year average of EBIT (cyclically adjusted EBIT);
(ii) compute a CAEE ratio for each security by dividing the security's enterprise value by its cyclically adjusted EBIT;
(iii) rank the securities by their CAEE ratios and group them into decile, quantile, or percentile groups;
(iv) select one or more securities from one or more predetermined decile, quantile, or percentile groups corresponding to the lowest CAEE values;
(v) determine weightings for the selected securities according to a weighting rule;
(vi) generate an output index or portfolio comprising the selected securities with the determined weightings; and
(vii) automatically rebalance the index or output portfolio when at least one of the selected securities enters or exits the one or more predetermined decile, quantile, or percentage groups.

14. The system of claim 13, wherein the processor is further configured to identify financial companies, including but not limited to banks, insurance firms, and investment companies, and substitute the CAEE ratio with a cyclically adjusted price-to-tangible-book-value ratio (CAPTBV), calculated by dividing the security's current market price by a multi-year inflation-adjusted average of tangible book value.

15. The system of claim 13, wherein the processor is further configured to transmit the output portfolio to an external interface in a structured file format selected from the group consisting of CSV, JSON, or FIX protocol.

16. The system of claim 13, wherein the output comprises a portfolio used to manage: ETFs (exchange traded funds), ETPs (exchange traded products), MFs (mutual funds), ETNs (exchange-traded notes), direct indexing strategies, SMAs (separately managed accounts), or Algorithmic trading systems.

17. The system of claim 13, wherein the processor is further configured to determine weightings for the selected securities using a weighting rule selected from the group consisting of: equal weighting, market capitalization weighting, revenue weighting, factor-based scoring, composite scores, or user-defined rules stored in memory and executed by the processor.

18. The system of claim 13, wherein rebalancing is triggered when the CAEE ratio of a selected security crosses a predefined threshold corresponding to its decile, quantile, or percentile group.

19. The system of claim 13, wherein rebalancing is performed on a predetermined schedule consisting of weekly or bi-monthly or monthly or quarterly or annually or semi-annually.

20. A non-transitory computer-readable medium storing instructions that, when executed by at least one processor, cause the processor to perform the method of claim 1.
